(19) United States
(12) Patent Application Publication
(10) Pub. No.: US 2007/0286315 A1
(43) Pub. Date: Dec. 13, 2007

(54) Digital signal processor, receiver, corrector and methods for the same

(76) Inventors: Ju-hyung Hong, Hwaseong-si (KR); Myung-hoon Sunwoo, Seoul (KR)

Correspondence Address: HARNESS, DICKEY & PIERCE, P.L.C., P.O. BOX 8910, RESTON, VA, 20195, US

(21) Appl. No.: 11/245,427

(22) Filed: Oct. 7, 2005

(30) Foreign Application Priority Data
Oct. 7, 2004 (KR) 10-2004-0079961

(51) Int. Cl. H04B 1/30

(52) U.S. Cl. 375/345; 375/E01.002

(57) ABSTRACT

A digital signal processor, a receiver, a corrector, and methods for the same are provided. An analog circuit may output sample data based on received input data. A digital circuit may generate a baseline wander error based on the sample data and output data output from the digital circuit. A baseline wander error correction value may be generated based on the generated baseline wander error.

### BACKGROUND OF THE INVENTION

This application claims priority under 35 U.S.C. §119 of Korean Patent Application No. 10-2004-0079961, filed on Oct. 7, 2004, in the Korean Intellectual Property Office, the contents of which are incorporated herein in its entirety by reference.

1. Field of the Invention

Example embodiments of the present invention relate to digital signal processors, receivers, correctors, and methods for the same.

2. Description of the Conventional Art

Conventional Fast Ethernet techniques may support data transmission speeds of, for example, 100 Mbps or higher. Conventional Gigabit Ethernet is an improved version of conventional Ethernet and may use the same, or substantially the same, digital signal processors as conventional fast Ethernet, for example, based on the IEEE 802.3 standard. 100 Mbps Ethernet technology may be based on, for example, IEEE 802.3u, and 1 Gbps Ethernet technology may be based on, for example, IEEE 802.3ab.

100BASE-TX, which is a form of fast Ethernet providing a transmission speed of 100 Mbps, may be implemented by integrating, for example, Copper Based Data Interface (CDDI) Physical Medium Dependent (PMD) technology using Category 5 ANSI X.TP9.5 unshielded twisted pair (UTP) or shielded twisted pair (STP) cables, Fiber Distributed Data Interface (FDDI) PMD technology using fiber-optic cables, Carrier Sense Multiple Access with Collision Detection (CSMA/CD) Media Access Control (MAC) technology in the Physical Coding Sub-Layer (PCS), or any other suitable technology.

100 Mbps Ethernet technologies may be divided into 100BASE TX using UTP and/or STP cables and 100BASE-FX using fiber-optic cables.

100BASE-TX may perform data transmission and receipt using two pairs of Category 5 UTP cables, and 1000BASE-T may perform data transmission and receipt using four pairs of twisted pair cables.

Gigabit Ethernet that may use copper cables to transmit or receive data may cause inter-symbol interference (ISI) due to, for example, frequency and signal attenuation along the copper cables and the frequency characteristics of a channel.

Baseline wander, describes vertical fluctuations of a direct current (DC) reference line of an incoming signal in a transformer between a transmitter and a twisted pair channel.

An Ethernet receiver using twisted pair cables may need to be able to suppress ISI and/or baseline wander. While an Ethernet receiver may suppress ISI using an adaptive equalizer, it may not suppress baseline wander without a baseline wander correction circuit.

In 100BASE-TX, input data may be converted into a multilevel transition (MLT)-3 signal, which may suppress emission of electromagnetic waves. MLT-3 coding may reduce the frequency of data and may reduce problems associated with twisted pair-based networks, such as, for example, bandwidth restrictions and/or electromagnetic wave emissions. When an Ethernet receiver is connected to a transmitter via an UTP cable, data may travel through a transformer. However, the transformer may not allow 50 KHz or lower frequency components to pass.

When MLT-3-coded data passes through the transformer, the DC offset of the MLT-3-coded data may vary because the transformer may filter out DC components of the MLT-3-coded data and output the rest of the MLT-3-coded data. An average level of the MLT-3-coded data may vary, and the pulse width of the MLT-3-coded data may be distorted. Baseline wander may occur in the MLT-3-coded data, and may cause jitter with increasing bit error rate.

FIG. 1 is a graph illustrating waveforms of data sequences passing through a conventional transformer of a conventional transmitter. Referring to FIG. 1, a DC reference line of data output from the transformer may vertically fluctuate because the transformer may filter out lower frequency components of input data.

At the physical layer, Ethernet using twisted pair cables may include a programmable gain amplifier, a timing recoverer, an adaptive equalizer, and a baseline wander corrector.

In order to receive data at higher speeds with reduced errors, a digital signal processor may operate based on interactions among components included within the digital signal processor.

In conventional digital signal processors, three methods of correcting a baseline wander error may be used. For example, a method of correcting a baseline wander error using an analog circuit unit of a digital signal processor; a method of estimating a baseline wander error using a digital circuit of the digital signal processor and correcting the baseline wander error using the analog circuit of the digital signal processor; and a method of correcting a baseline wander error using the digital circuit of the digital signal processor.

FIG. 2 is a block diagram of a conventional digital signal processor 20 that may correct a baseline wander error using an analog circuit. Referring to FIG. 2, the conventional digital signal processor 20 may be divided into an analog circuit 21, which may precede an analog-to-digital converter 23, and a digital circuit 25, which may be subsequent to the analog-to-digital converter 23. The digital circuit 25 may be an equalizer. The baseline wander corrector 22 may correct a baseline wander error, the analog-to-digital converter 23 may convert the correction result into a digital signal, and the equalizer 25 may recover data from the digital signal.

The equalizer 25 may include a forward filter 26, a slicer 27, a backward filter 28, and an adder 29. The digital signal processor 20 may estimate and correct a baseline wander error using the analog circuit 21. As the integration density of digital device becomes greater than the integration density of analog devices, digitalizing conventional digital signal processors may become increasingly important due to an expectation of decreased complexity and/or power consumption.

FIG. 3A is a block diagram of a conventional digital signal processor 30, which may estimate a baseline wander error using a digital circuit 35 and may correct the estimated baseline wander error using an analog circuit 31. FIG.3B is a block diagram of a conventional digital signal processor 40, which may estimate a baseline wander error using a digital circuit 45 and may correct the estimated baseline wander error using an analog circuit 41.

Referring to FIGS. 3A and 3B, the conventional digital signal processor 30 may include a digital-to-analog converter (not shown) and a low-pass filter (not shown) for correcting a baseline wander error using the analog circuit 35. Thus, the conventional digital signal processor 30 may need additional hardware included therein in order to correct a baseline wander error.

The conventional digital signal processor 30 may include the analog circuit 31, an analog-to-digital converter 23, and the digital circuit 35. The conventional signal processor 30 may estimate a base line wander error by subtracting, for example, a signal output from an adder 29, from a signal output from a slicer 27.

Referring to FIG. 3B, the conventional digital signal processor 40 may include an analog circuit 41, an analog-to-digital converter 23, and a digital circuit 45. The conventional digital signal processor 40 may estimate a baseline wander error by subtracting a signal output from the analog-to-digital converter 23 from a signal output from the slicer 27, and unnecessary interaction between the equalizer 45 and a baseline wander corrector 22 may be suppressed.

If the baseline wander corrector 22 has the same, or substantially the same, circuit structure as the equalizer 45, a mean square error of the equalizer 45 may be reduced by, for example, 1 dB.

FIG. 4 is a block diagram of another example of a conventional digital signal processor 50, which may estimate and correct a baseline wander error using a digital circuit 55, FIG. 5 is a block diagram of another example of the conventional digital signal processor 50 of FIG. 4, and FIG. 6 is a block diagram of another example of the conventional digital signal processor 50 of FIG. 4.

Referring to FIG. 4, the conventional digital signal processor 50 may include an equalizer 55 and a baseline corrector 22, which may be located ahead of the equalizer 55 and may include a pre-filter. The pre-filter may subtract a symbol (hereinafter referred to as a current symbol) currently being input to the equalizer 55 from a symbol (hereinafter referred to as a previous symbol) previously input to the equalizer 55. The conventional digital signal processor 50 may suppress baseline wander and may perform part of an MLT-3 decoding operation.

The conventional digital signal processor 50, using the pre-filter, may correct a baseline wander error using the previous symbol and the current symbol. Since the conventional digital signal processor 50 observes two symbols for estimating the baseline wander error, it may not estimate the baseline wander error with sufficient accuracy.

Referring to FIG. 5, the conventional digital signal processor 60 may estimate a baseline wander error based on an error of an equalizer 65 and may suppress baseline wander from an input port of the equalizer 65. The conventional digital signal processor 70, may estimate a baseline wander error based on an error of an equalizer 75 and may suppress baseline wander from an output port of the equalizer 75.

Each of the conventional digital signal processors 60 and 70 may accumulate previous errors of a corresponding equalizer (65 or 75), multiply the accumulation result by a correction constant, and correct a baseline wander error using the product. The conventional digital signal processors 60 and 70 may be similar, or substantially similar, to each other in how they estimate a baseline wander error but may be different, or substantially different, from each other in which portions of the equalizers 65 and 75 they suppress baseline wander.

In the conventional digital signal processors 60 and 70 that may estimate a baseline wander error using errors of equalizers 65 and 75, respectively, the baseline wander error may not be estimated with sufficient accuracy because signals output from the equalizers 65 and 75, at an earlier stage of adaptive equalization, may be affected by an imperfectly converged equalization coefficient.

### SUMMARY OF THE INVENTION

Example embodiments of the present invention may allow for improved estimation and/or correction of a baseline wander error with suppressed (e.g., without) interaction with an equalizer.

An example embodiment of the present invention provides a digital signal processor, which may include an analog circuit and a digital circuit. The analog circuit may be adapted to output sample data based on received input data. The digital circuit may be adapted to generate a baseline wander error based on the sample data and output data output from the digital circuit, and generate a baseline wander error correction value based on the generated baseline wander error.

Another example embodiment of the present invention provides a corrector for use in a receiver, wherein the corrector may be adapted to average a baseline wander error of a current symbol and a plurality of baseline wander errors of a plurality of previous symbols and output an average as a baseline wander error correction value for use in correcting a baseline wander error.

Another example embodiment of the present invention provides a receiver, which may include a digital signal processor. The digital signal processor may further include an analog circuit and a digital circuit. The analog circuit may be adapted to output sample data based on received input data. The digital circuit may be adapted to generate a baseline wander error based on the sample data and output data output from the digital circuit, and generate a baseline wander error correction value based on the generated baseline wander error.

Another example embodiment of the present invention provides a method for correcting baseline wander error. The method may comprise outputting sample data based on received input data; generating a baseline wander error based on the sample data and output data output from the digital circuit; and generating a baseline wander error correction value for correcting baseline wander error based on the generated baseline wander error.

In example embodiments of the present invention, the digital circuit may further include an equalizer, an error estimator, and an error corrector. The error estimator may obtain a baseline wander error from sample data input to the equalizer and output data output from the equalizer, and the error corrector may generate the output data by correcting the sample data in response to the baseline wander error and data output from the equalizer.

In example embodiments of the present invention, the error corrector may include a baseline wander corrector, a first adder, and a slicer. The baseline wander corrector may generate a baseline wander error correction value by correcting the baseline wander error. The first adder may add the data output from the equalizer and the baseline wander error correction value. The slicer may compare data the sum output from the first adder with a value and output the output data based on the comparison.

In example embodiments of the present invention, the baseline wander corrector may have a filter structure or a pre-filter structure with a plurality of taps. In example embodiments of the present invention, the baseline wander corrector may bit-map the baseline wander error.

In example embodiments of the present invention, the baseline wander corrector may average a baseline wander error of a current symbol and a plurality of baseline wander errors of a plurality of previous symbols and may output an average as the baseline wander error correction value.

In example embodiments of the present invention, the error estimator may further include a delay device and a second adder. The delay device may generate the delayed sample data by delaying the sample data and the second adder may generate the baseline wander error by subtracting the delayed sample data from the output data.

In example embodiments of the present invention, the equalizer may further include feed-forward filter, a feed-back filter, and a third adder. The feed-forward filter may filter the sample data. The feed-back filter may filter the output data. The third adder may add data output from the feed-forward filter and data output from the feed-back filter and may output the sum as an output of the equalizer.

In example embodiments of the present invention, the digital signal processor may further include a fourth adder. The fourth adder may generate an equalization error by subtracting data output from the first adder from the output data and outputs the equalization error to the equalizer.

In example embodiments of the present invention, the digital signal processor may further include a recovery unit and a controller. The recovery unit may generate a position control signal in response to the equalization error and the sample data. The controller may generate an amplification control signal in response to the sample data.

In example embodiments of the present invention, the analog circuit may generate the sample data in response to a baseband signal.

In example embodiments of the present invention, the analog circuit may further include an amplifier and an analog-to-digital controller. The amplifier may control the degree to which the baseband signal may be amplified in response to the amplification control signal. The analog-to-digital controller may generate the sample data from the baseband signal through sampling in response to the position control signal.

In example embodiments of the present invention, the sample data may be obtained by converting a baseband signal into a digital signal.

In example embodiments of the present invention, the corrector may further include a plurality of shift units, a plurality of delay units, and a plurality of adders. The plurality of shift units may perform a bit-mapping operation on the baseline wander error. The plurality of delay units may delay each of the plurality of bit-mapped baseline wander errors. The plurality of adders for may add a current bit-mapped baseline wander error and a previous delayed bit-mapped baseline wander error, and outputting sum as the baseline wander error correction value.

### BRIEF DESCRIPTION OF THE DRAWINGS

Example embodiments of the present invention will become more apparent by describing in detail the attached drawings in which:

FIG. 1 is a diagram illustrating waveforms of data sequences passing through a conventional transformer of a conventional transmitter;

FIG. 2 is a block diagram illustrating an example of a conventional digital signal processor;

FIG. 3A is a block diagram illustrating another example of a conventional digital signal processor;

FIG. 3B is a block diagram illustrating another example of a conventional digital signal processor;

FIG. 4 is a block diagram illustrating another example of a conventional digital signal processor;

FIG. 5 is a block diagram illustrating another example of a conventional digital signal processor;

FIG. 6 is a block diagram illustrating another example of a conventional digital signal processor;

FIG. 7 is a block diagram illustrating a digital signal processor, according to an example embodiment of the present invention;

FIG. 8 is a block diagram illustrating a baseline wander corrector, according to an example embodiment of the present invention; and

FIG. 9 is a diagram comparing errors between input and output data from a slicer of a digital signal processor, according to an example embodiment of the present invention and a conventional slicer.

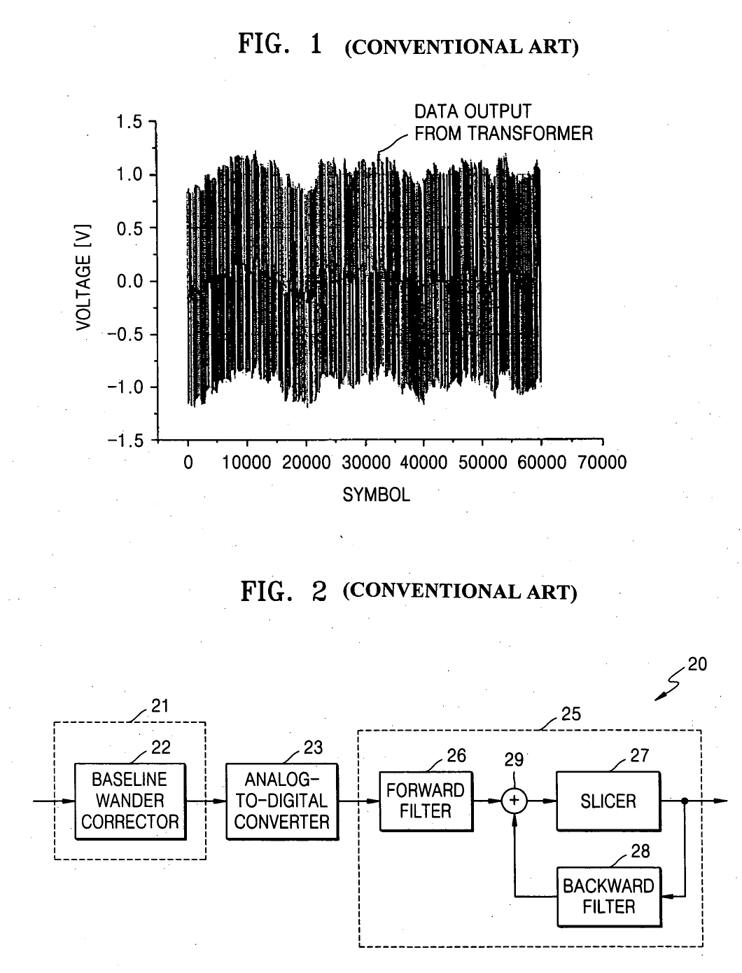

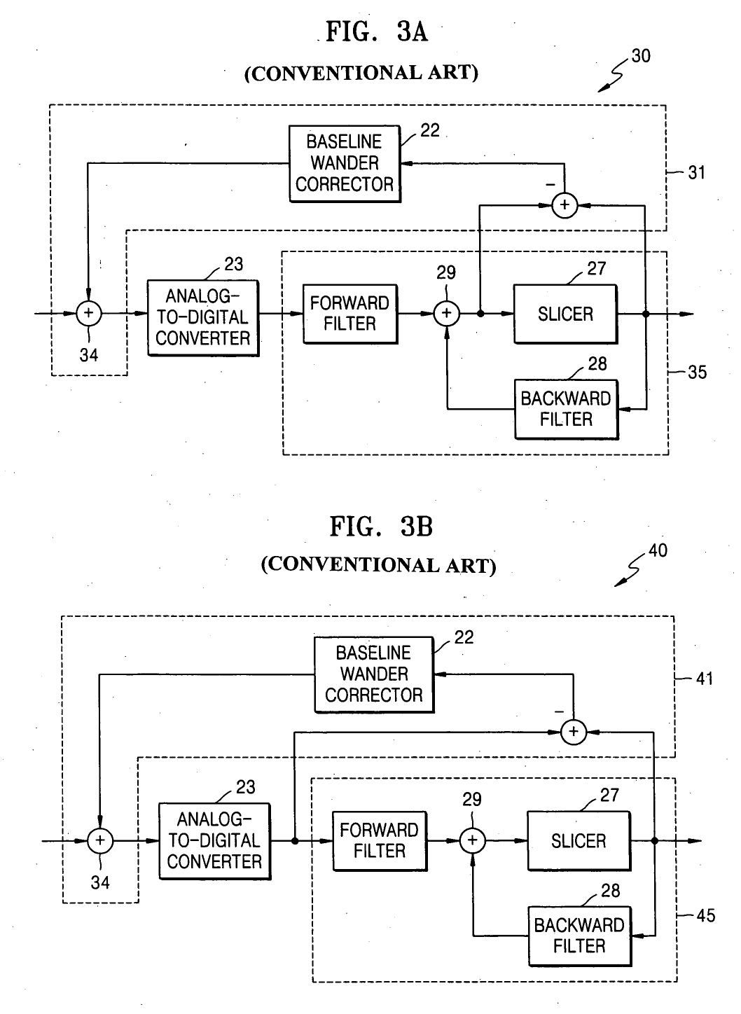

### DETAILED DESCRIPTION OF EXAMPLE EMBODIMENTS OF THE PRESENT INVENTION

Example embodiments of the present invention will now be described more fully with reference to the accompanying drawings in which example embodiments of the invention is shown. In the drawings, like reference numerals represent like elements.

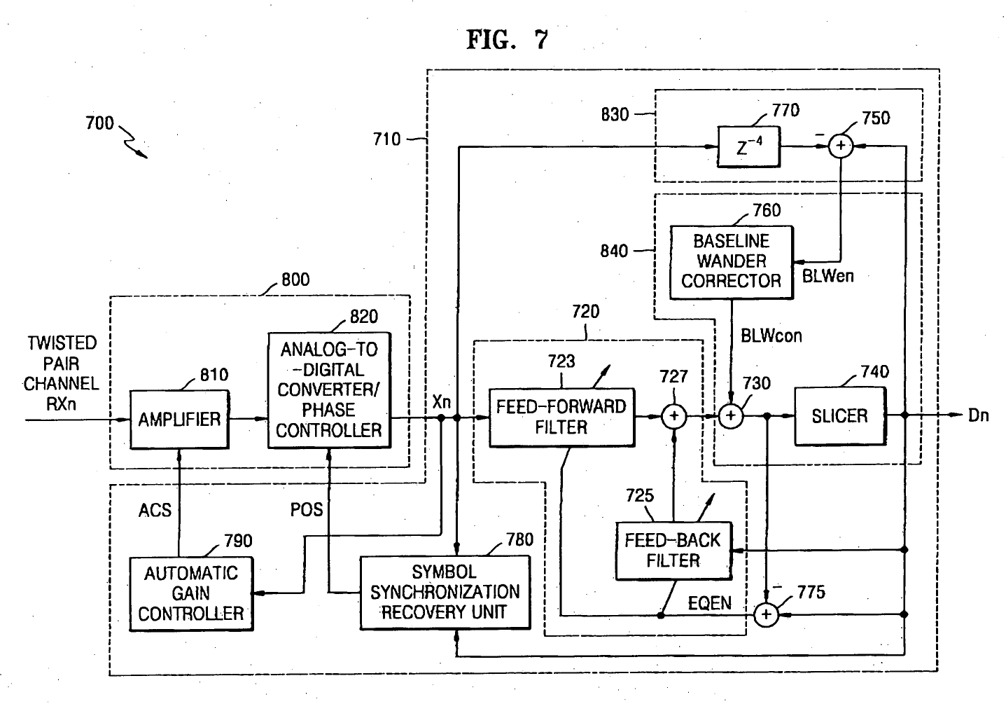

FIG. 7 is a block diagram illustrating a digital signal processor 700, according to an example embodiment of the present invention. Referring to FIG. 7, the digital signal processor 700 may include an analog circuit 800 and a digital circuit 710. Examples of structures and operations of the analog circuit 800 will be described in more detail below. The digital circuit 710 may include an equalizer (e.g., a decision feedback equalizer (DFE)) 720, an adder 730, a slicer 740, an adder 750, and a baseline wander corrector 760.

The equalizer 720 may receive sample data Xn and correct an attenuated frequency of the sample data Xn, which may have been attenuated in a transmission path (not shown). The sample data Xn may be obtained by converting an analog base-band signal RXn, into a digital signal.

The equalizer 720 may include a feed-forward filter 723, which may filter the sample data Xn, a feed-back filter 725, which may filter output data Dn, and an adder 727, which may add the output of the feed-forward filter 723 and the output of the feed-back filter 725. The sum may be output from the adder 727 as an output of the equalizer 720.

The baseline wander corrector 760 may estimate a baseline wander error BLWen (hereinafter referred to as the current baseline wander error) of a current symbol, and may suppress interaction between the equalizer 720 and the baseline wander corrector 760. For example, the baseline wander corrector 760 may subtract the sample data Xn input to the feed-forward filter 723, from the output data Dn output from the slicer 740.

The baseline wander corrector 760 may correct the current baseline wander error BLWen, for example, by adding the current baseline wander error BLWen and the output of the adder 727, that is, the sum of the output of the feed-forward filter 723 and the output of the feed-back filter 725.

The adder 750 may generate the current baseline wander error BLWen, for example, by subtracting delayed sample data. The delayed sample data may be obtained by delaying the sample data Xn with respect to the output data Dn output from the slicer 740.

The delayed sample data may be generated by a delay device 770. The delay device 770 may delay the sample data Xn for, for example, a period in which the sample data Xn is processed by the equalizer 720. That is, a period between the input and output of the sample data Xn to and from the equalizer (e.g., DFE) 720.

The current baseline wander error BLWen may be estimated irrespective of the operation of the equalizer 720, and may not be estimated with sufficient accuracy, for example, when the output of the equalizer 720 is affected by a converged equalization coefficient (e.g., an imperfectly converged equalization coefficient).

The adder 730 may add the output of the equalizer 720 and a baseline wander error correction value BLWcon output from the BLW corrector 760 so that baseline wander may be suppressed in the output of the equalizer 720. The sum output from the adder 730 may be input to the slicer 740.

The slicer 740 may compare the sum, output from the adder 730 with a value (e.g., a threshold value), and may output the output data Dn. The slicer 740 may have the value (e.g., a threshold value), compare data input thereto with the value (e.g., a threshold value), and output the output data Dn based on the comparison. The output data Dn output from the slicer 740 may be recovered data, for example, original data, which may have been transmitted to the digital signal processor 700 from a transmitter (not shown).

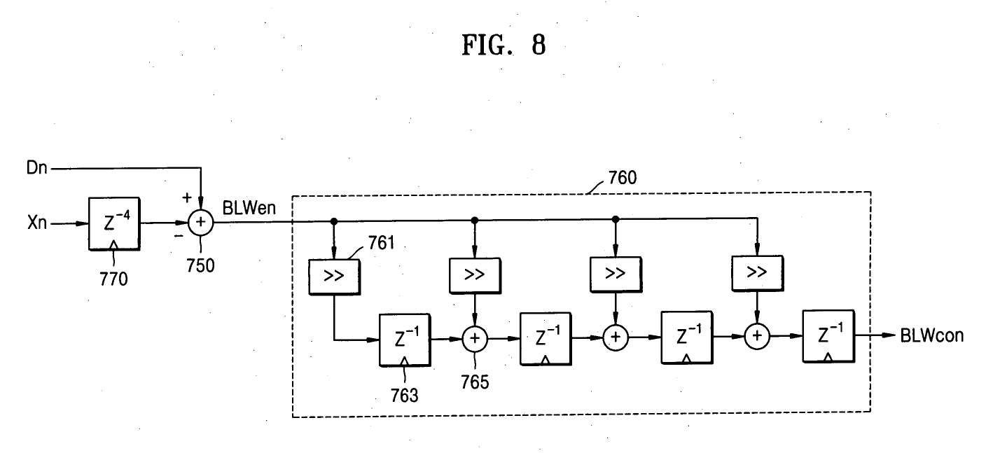

The baseline wander corrector 760 may correct the current baseline wander error BLWen and may output the baseline wander error correction value BLWcon. The structure of the baseline wander corrector 760, which may estimate the current baseline wander error BLWen, for example, without the need for the output of the equalizer 720 will be described with reference to FIG. 8.

FIG. 8 is a block diagram illustrating a baseline wander corrector, according to an example embodiment of the present invention. Referring to FIG. 8, the baseline wander corrector 760 may be structured, for example, as a filter. The baseline wander corrector 760 may include shift units 761, delay units 763, and adders 765. The shift unit 761 may be, for example, multipliers or any other suitable shift unit.

For example, the baseline wander corrector 760 may have the structure of a 4-tap pre-filter. In a pre-filter, delay units and shift units may be arranged in a manner opposite to a manner in which delay units and shift units of a conventional filter may be arranged.

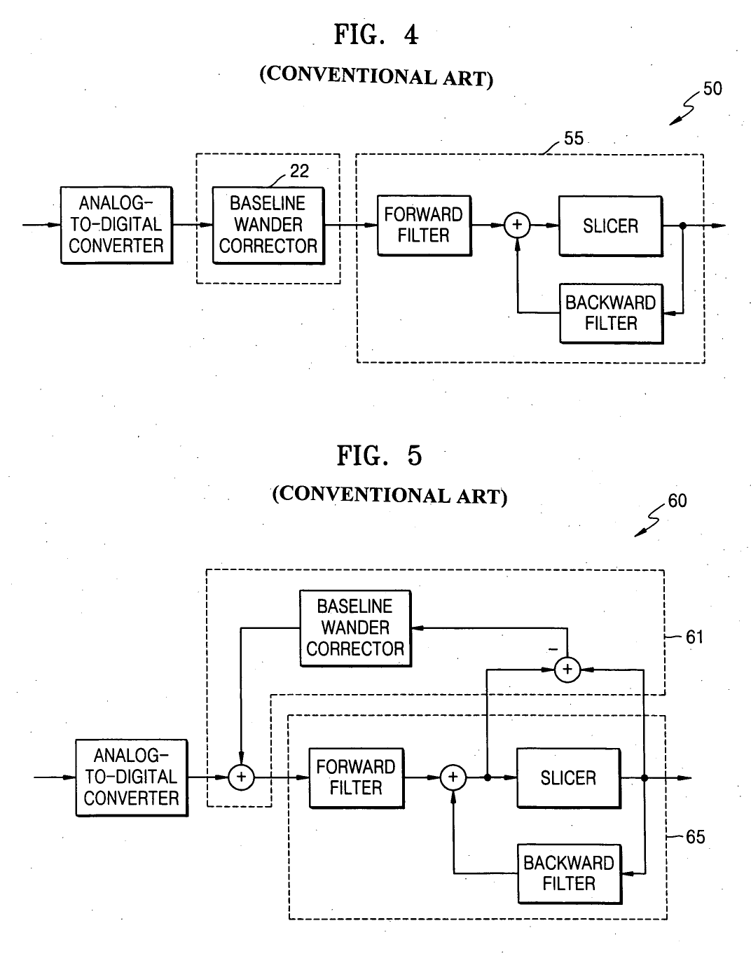

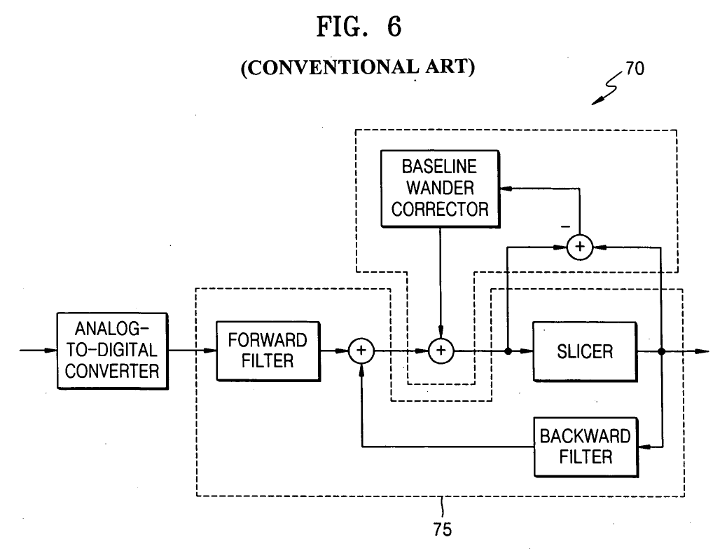

The conventional baseline wander corrector 22 of FIG. 4 may correct a baseline wander error using two symbols, for example, a previous symbol and a current symbol. The baseline wander corrector 760 of FIG. 8 may average the current baseline wander error BLWen and, for example, a plurality (e.g., three) previous baseline wander errors BLWen, and may output an average of the baseline wander errors (e.g., four baseline wander errors) as the baseline error correction value BLWcon.

The operation of the baseline wander corrector 760 may be defined by the following equation:

$$BLWen = Dn - {X}_{n - 4}$$

$$BLWcon = {\sum }_{i = n - 3}^{n} BLWei \times 0.25 = {\sum }_{i = n - 3}^{n} ( BLWei >> 2 bit ) .$$

The baseline wander corrector 760 may have, for example, a pre-filter structure. The baseline wander corrector 760 may average the baseline wander errors (e.g., four baseline wander errors) BLWen by performing, for example, a bit-mapping operation (e.g., 2-bit-mapping operation) on the baseline wander errors BLWen using the shift units 761. The bit-mapping results may be added.

Referring to FIG. 7, the digital signal processor 700 may further include an adder 775, which may subtract the output of the adder 730 from the output data Dn and may output the subtraction result, for example, an equalization error EQEN, to the equalizer 720. The equalization error EQEN output from the adder 775, may be used in estimating the current baseline wander error BLWen, as shown in FIG. 7.

The digital circuit 710 of the digital signal processor 700 may also include a recovery unit (e.g., a symbol synchronization recovery unit) 780 and a controller (e.g., an automatic gain controller (AGC)) 790. The recovery unit 780 may generate a control signal (e.g., a sampling position control signal) POS in response to the equalization error EQEUN and the sample data Xn. The controller 790 may generate another control signal (e.g., an amplification control signal) ACS in response to the sample data Xn.

The digital signal processor 760 may also include the analog circuit 800, which may generate the sample data Xn, for example, based on the base-band signal RXn. The analog circuit 800 may include an amplifier 810 and an analog-to-digital converter/phase controller 820.

The amplifier 810 may control the degree to which the base-band signal RXn may be amplified in response to the control signal ACS. The analog-to-digital converter/phase controller 820 may generate the sample data Xn from the base-band signal RXn through sampling in response to the control signal POS. The analog-to-digital converter/phase controller 820 may include, for example, an analog-to-digital converter and a phase locked loop (PLL).

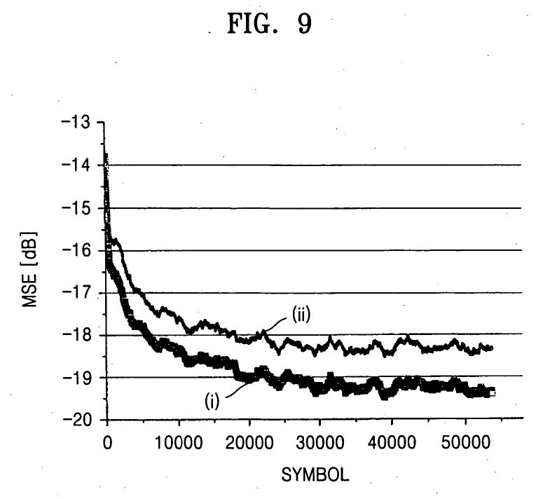

FIG. 9 is a diagram comparing example errors between data input to, and output from, a slicer of a digital signal processor, according to an example embodiment of the present invention, with errors between data input to and output from a slicer within a conventional digital signal processor. Referring to FIG. 9, (i) represents a variation of a mean square error (MSE) of the digital signal processor, according to an example embodiment of the present invention, which may be a square of an error between data input to, and output from, the slicer of the digital signal processor, according to an example embodiment of the present invention. (ii) represents a variation of an MSE of the conventional digital signal processor, which may be a square of an error between data input to, and output from, the slicer within a conventional digital signal processor. The MSE of the digital signal processor, according to an example embodiment of the present invention, may be approximately 1 dB higher than the MSE of the conventional digital signal processor.

A digital signal processor, according to another example embodiment of the present invention, will be described below. The digital signal processor may include an equalizer (e.g., a decision feedback equalizer (DFE)) 720, an error estimator 830, and an error corrector 840. The error estimator 830 may estimate a baseline wander error based on sample data input to the equalizer and output data. The error corrector 840 may error-correct the output data in response to the baseline wander error and the data output from the equalizer (e.g., DFE) 720, and may output the error-corrected output data.

The digital signal processor may have a structure, which may allow for the estimation and/or correction of the baseline wander error with little or no interaction between the error estimator and/or corrector and the equalizer.

Again referring to FIG. 7, the digital signal processor 700 may include an error corrector 840, which may include the baseline wander corrector 760, the adder 730, and the slicer 740, an error estimator 830, which may include the delay device 770 and the adder 750, and the equalizer (e.g., a decision feedback equalizer (DFE)) 720. Elements of the error corrector 840, the error estimator 830, and the equalizer 720 have already been described above and will be omitted.

As described above, example embodiments of the digital signal processor, according to the present invention, may estimate a baseline wander error using data output from a slicer and sample data delayed by a period greater than or equal to the amount of delay applied to the data input to an equalizer (e.g., a decision feedback equalizer (DFE)). Thus, example embodiments of the digital signal processor, according to example embodiments the present invention, may suppress interaction between the equalizer (e.g., a decision feedback equalizer (DFE)) 720 and a baseline wander corrector 760.

Example embodiments of the present invention, for example, the digital signal processor 700, may be included in, or used in conjunction with, for example, any conventional receiver (e.g., Ethernet receiver, (not shown)).

A digital signal processor, according to example embodiments of the present invention, may estimate and/or correct the baseline wander error using a digital circuit, which may include the baseline wander corrector. A digital signal processor, according to example embodiments of the present invention, may not include a digital-to-analog converter and/or a filter (e.g., a low-pass filter).

Example embodiments of the baseline wander corrector of the digital signal processor, according to the present invention, may obtain a baseline wander error correction value of a current symbol, for example, after observing the current symbol and a plurality (e.g., three) of previous symbols. A digital signal processor, according to example embodiments of the present invention, may more effectively perform a baseline wander correction operation in a channel, which may have a fluctuating baseline wander error and/or a higher baseline wander error.

As compared with a conventional digital signal processor, the digital signal processor 700 may more efficiently suppress baseline wander from data input and/or may more efficiently suppress errors in data input to the slicer 740.

The baseline wander corrector 760 may not include multipliers, and the structure of the baseline wander corrector 760 may be simplified.

Example embodiments of the present invention have been described with regard to baseline wander error and error correction. However, it will be understood that example embodiments of the present invention may be used to estimate and/or correct any attenuation error of a transmission path.

While example embodiments of the present invention has been particularly shown and described with reference to example embodiments thereof, it will be understood by those of ordinary skill in the art that various changes in form and details may be made therein without departing from the spirit and scope of the present invention as defined by the following claims.

What is claimed is:

1. A digital signal processor for a receiver, the digital signal processor comprising:
an analog circuit adapted to output sample data based on received input data; and
a digital circuit adapted to generate a baseline wander error based on the sample data and output data output from the digital circuit, and generate a baseline wander error correction value based on the generated baseline wander error.

2. The digital signal processor of claim 1, wherein the digital circuit further includes,
an equalizer which receives sample data and corrects a frequency level of the sample data that has been attenuated in a transmission path,
an error estimator, which obtains the baseline wander error from sample data input to the equalizer and output data output from the equalizer; and
an error corrector, which generates the output data by correcting the sample data in response to the baseline wander error and data output from the equalizer.

3. The digital signal processor of claim 2, wherein the error corrector includes,
a baseline wander corrector, which generates a baseline wander error correction value by correcting the baseline wander error,
a first adder, which adds the data output from the equalizer and the baseline wander error correction value, and
a slicer, which compares data the sum output from the first adder with a value and output the output data based on the comparison.

4. The digital signal processor of claim 3, wherein the baseline wander corrector has a filter structure.

5. The digital signal processor of claim 3, wherein the baseline wander corrector has a pre-filter structure with a plurality of taps.

6. The digital signal processor of claim 3, wherein the baseline wander corrector bit-maps the baseline wander error.

7. The digital signal processor of claim 3, wherein the baseline wander corrector averages a baseline wander error of a current symbol and a plurality of baseline wander errors of a plurality of previous symbols and outputs an average as the baseline wander error correction value.

8. The digital signal processor of claim 2, wherein the error estimator includes,
a delay device, which generates the delayed sample data by delaying the sample data; and
a second adder, which generates the baseline wander error by subtracting the delayed sample data from the output data.

9. The digital signal processor of claim 2, wherein the equalizer includes,
a feed-forward filter, which filters the sample data,
a feed-back filter, which filters the output data, and
a third adder, which adds data output from the feed-forward filter and data output from the feed-back filter and outputs the sum as an output of the equalizer.

10. The digital signal processor of claim 2 further including,
a fourth adder, which generates an equalization error by subtracting data output from the first adder from the output data and outputs the equalization error to the equalizer.

11. The digital signal processor of claim 10, further including,
a recovery unit, which generates a position control signal in response to the equalization error and the sample data, and
a controller, which generates an amplification control signal in response to the sample data.

12. The digital signal processor of claim 1, wherein the analog circuit generates the sample data in response to a baseband signal.

13. The digital signal processor of claim 1, wherein the analog circuit includes,
an amplifier, which controls the degree to which the baseband signal is amplified in response to the amplification control signal; and
an analog-to-digital controller, which generates the sample data from the baseband signal through sampling in response to the position control signal.

14. The digital signal processor of claim 13, wherein the sample data is obtained by converting a baseband signal into a digital signal.

15. A corrector for use in a receiver, wherein the corrector is adapted to average a baseline wander error of a current symbol and a plurality of baseline wander errors of a plurality of previous symbols and output an average as a baseline wander error correction value for use in correcting a baseline wander error.

16. The corrector of claim 15, further including,
a plurality of shift units for performing a bit-mapping operation on the baseline wander error,
a plurality of delay units for delaying each of the plurality of bit-mapped baseline wander errors, and
a plurality of adders for adding a current bit-mapped baseline wander error and a previous delayed bit-mapped baseline wander error, and outputting sum as the baseline wander error correction value.

17. A receiver, the receiver comprising:
a digital signal processor including,
an analog circuit adapted to output sample data based on received input data; and
a digital circuit adapted generate a baseline wander error based on the sample data and output data output from the digital circuit, and generate a baseline wander error correction value based on the generated baseline wander error.

18. A method for correcting baseline wander error, the method comprising:
outputting sample data based on received input data;
generating a baseline wander error based on the sample data and output data output from the digital circuit; and
generating a baseline wander error correction value for correcting baseline wander error based on the generated baseline wander error.

19. A digital signal processor for performing the method of claim 18.

20. A receiver including the digital signal processor of claim 19.

21. A digital signal processor including the corrector of claim 15.

22. A receiver including the digital signal processor of claim 21.

23. A receiver including the digital signal processor of claim 1.
